(19) United States
(12) Patent Application Publication
(10) Pub. No.: US 2021/0201031 A1
(43) Pub. Date: Jul. 1, 2021

(54) METHOD AND SYSTEM FOR PROVIDING AUGMENTED REALITY INFORMATION FOR AN OBJECT

(71) Applicant: Wipro Limited, Bangalore (IN)

(72) Inventors: Ashok CHANDRAN, Alappuzha (IN); Kailas VALIYAVEETIL, Kannur (IN)

(21) Appl. No.: 16/798,623

(22) Filed: Feb. 24, 2020

(30) Foreign Application Priority Data
Dec. 31, 2019 (IN) 201941054786

(51) Int. Cl. G06K 9/00; G06T 19/00; G06N 20/00

(52) U.S. Cl. CPC G06K 9/00671; G06T 2219/004; G06N 20/00; G06T 19/006

(57) ABSTRACT

Disclosed herein is a method and augmented reality system for providing augmented reality information for an object. The system receives an image from an image capturing device and identifies one or more objects of interest. Thereafter, system identifies location of each object of interest in the image. The system retrieves a virtual marker for each object of interest from a virtual marker repository. The system places virtual marker at the identified location corresponding to each object of interest. The image along with marker is provided to a client device. At the client device, the marker is identified in the image. For each identified marker, the system retrieves augmented reality information from augmented data repository. The augmented reality information is displayed for each object of interest in the image. The present disclosure automatically places virtual marker and provides augmented information associated with object by identifying object of interest in the image.

### TECHNICAL FIELD

The present subject matter is generally related to Augmented Reality (AR) and more particularly, but not exclusively, to a method and a system for providing augmented reality information for an object.

### BACKGROUND

In Augmented Reality (AR), physical markers are provided near an object or embedded on the object to indicate information associated with the object. The physical markers may be identified by an application capturing image of the object. Once the object is identified, the augmented information about the object may be displayed. This means for each object, the physical marker images may be embedded. The problem with the physical marker is that for each object for which augmented information must be displayed, a physical marker must be attached, which increases the cost as the number of objects increases. As an example, if augmented information must be displayed for engine parts then physical markers has to be attached to all the engine parts.

Further, the existing methods have limitations in terms of efficient object identification and estimation of object category and uniquely identifying an object among objects of similar shapes. Also, in the existing methods the markers are manually provided and hence consumes more time.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method of providing augmented reality information for an object. The method comprises identifying, by an Augmented Reality (AR) system, one or more objects of interest in a received image. Thereafter, the method comprises identifying a location of each of the one or more objects of interest in the received image. The method further comprises retrieving a virtual marker corresponding to each of the identified one or more objects of interest from a virtual marker repository associated with the AR system. Once the virtual marker is retrieved, the method comprises placing the virtual marker at the identified location corresponding to each of the one or more objects of interest. Thereafter, the image with the marker is provided to a client device. At the client device, the method comprises providing augmented reality information corresponding to each of the objects of interest based on the virtual marker.

Further, the present disclosure discloses a system for providing augmented reality information for an object. The system comprises a processor and a memory communicatively coupled to the processor. The memory stores the processor-executable instructions, which, on execution, causes the processor to identify one or more objects of interest in a received image. Further, the processor identifies a location of each of the one or more objects of interest in the received image. Thereafter, the processor retrieves a virtual marker corresponding to each of the identified one or more objects of interest from a virtual marker repository associated with the AR system. Once the virtual marker is retrieved, the processor places the virtual marker at the identified location corresponding to each of the one or more objects of interest. Thereafter, the processor provides augmented reality information corresponding to each of the objects of interest at a client device based on the virtual marker.

Furthermore, the present disclosure comprises a non-transitory computer readable medium including instructions stored thereon that when processed by at least one processor causes the processor to providing augmented reality information for an object. Further, the instructions cause the processor to identify one or more objects of interest in a received image. Furthermore, the instructions cause the processor to identify a location of each of the one or more objects of interest in the received image. Likewise, the instructions cause the processor to retrieve a virtual marker corresponding to each of the identified one or more objects of interest from a virtual marker repository 109 associated with the AR system 103. Thereafter, the instructions cause the processor to place the virtual marker at the identified location corresponding to each of the one or more objects of interest. Finally, the instructions cause the processor to provide augmented reality information corresponding to each of the objects of interest based on the virtual marker when the image is received at a client device 105 associated with the AR system 103.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary architecture for providing augmented reality information for an object in accordance with some embodiments of the present disclosure;

FIG. 2 shows a block diagram of an Augmented Reality (AR) system in accordance with some embodiments of the present disclosure;

FIGS. 3a-3d collectively illustrate exemplary method of providing augmented reality information for an object in accordance with some embodiments of the present disclosure;

FIG. 4 shows a flowchart illustrating method of providing augmented reality information for an object accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure. The terms “comprises”, “comprising”, “includes”, “including” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method. The present disclosure relates to a method and an Augmented Reality (AR) system [alternatively referred as system] for providing augmented reality information for an object. At first, the AR system may receive an image from an image capturing device associated with the AR system. Upon receiving the image, the AR system may identify one or more objects of interest. The one or more objects of interest may be identified using machine learning techniques. Further, the AR system may identify location of each of the one or more objects of interest in the received image. Thereafter, the AR system may retrieve a virtual marker corresponding to each of the identified objects of interest from a virtual marker repository associated with the AR system. The retrieved virtual marker may be placed at the identified location corresponding to each of the one or more objects of interest. Thereafter, the image comprising the virtual marker may be provided to a client device. At the client device, an AR application associated with the AR system may identify the virtual marker corresponding to each of the one or more objects of interest in the received image. Once the virtual marker is identified, the AR application may retrieve augmented reality information corresponding to each virtual marker from an augmented data repository associated with the AR system. The augmented reality information may be the information associated with the object such as object type, object shape, object color and the like. Which may be provided in the form of text, audio or video. The retrieved augmented reality information may be added to each virtual marker and the augmented reality information may be provided for each object of interest. In this manner, the present disclosure discloses a method for automatically adding the virtual marker to objects of interest and also providing augmented reality information for the objects of interest in the image.

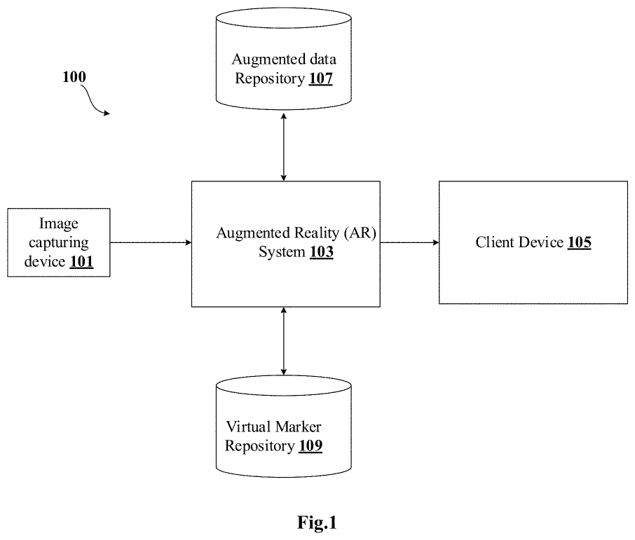

FIG. 1 shows an exemplary architecture for providing augmented reality information for an object in accordance with some embodiments of the present disclosure.

The architecture 100 may include an image capturing device 101, an Augmented Reality (AR) system 103 [alternatively referred as system], a client device 105, an augmented data repository 107 and a virtual marker repository 109. The image capturing device 101 may capture images or videos. The AR system 103 may receive the images or videos from the image capturing device 101. The videos may be divided into one or more frames or images for further processing by the AR system 103. Once the image is received, the AR system 103 may identify one or more objects of interest in the image. As an example, the received image may be of an engine. The one or more objects of interest in the received image may be parts of the engine. To identify the one or more objects of interest, the AR system 103 may first extract one or more features in the image such as shape, color and the like. The extracted features are fed to a machine learning model which is trained to identify the one or more objects of interest. Further, the AR system 103 may identify a location of the one or more objects of interest in the image. As an example, but not limited to, the location may be identified using image segmentation techniques. Once the location is identified, the AR system 103 may retrieve a virtual marker for each of the identified one or more objects of interest from the virtual marker repository 109. Each object may be associated with the virtual marker. The virtual marker may be represented as a 2 dimensional image. As an example, the virtual marker may be a “Hiro marker”. The AR system 103 may place the virtual marker at the identified location for each of the one or more objects of interest. Once the virtual marker is placed, the image may be provided to a client device 105. The client device 105 may be configured with AR application. The AR application may identify the virtual marker in the received image. Once the virtual marker is identified, the AR application may retrieve augmented reality information for each of the identified virtual marker from the augmented data repository 107. The AR application may add the AR information for each virtual marker and provide the AR information to each of the object of interest when the image is displayed on the client device 105.

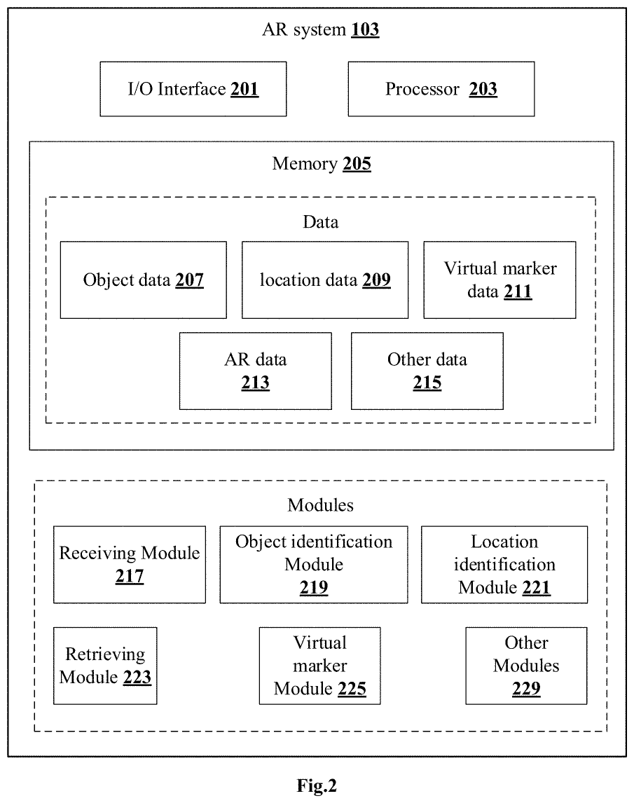

FIG. 2 shows a block diagram of an AR system in accordance with some embodiments of the present disclosure.

In some implementations, the AR system 103 may include I/O interface 201, a processor 203 and a memory 205. The I/O interface 201 may be configured to receive the image from the image capturing device 101 and to provide the image along with marker to the client device 105. The processor 203 may be configured to receive the image and process the image for adding the virtual marker and for providing augmented reality information associated with the object. The AR system 103 may include data and modules. As an example, the data is stored in a memory 205 configured in the AR system 103 as shown in the FIG. 2. In one embodiment, the data may include object data 207, location data 209, virtual marker data 211, augmented reality data 213 and other data 215. In the illustrated FIG. 2, modules are described herein in detail.

In some embodiments, the data may be stored in the memory 205 in form of various data structures. Additionally, the data can be organized using data models, such as relational or hierarchical data models. The other data 215 may store data, including temporary data and temporary files, generated by the modules for performing the various functions of the AR system 103.

In some embodiments, the data stored in the memory 205 may be processed by the modules of the AR system 103. The modules may be stored within the memory 205. In an example, the modules communicatively coupled to the processor 203 configured in the AR system 103, may also be present outside the memory 205 as shown in FIG. 2 and implemented as hardware. As used herein, the term modules may refer to an Application Specific Integrated Circuit (ASIC), an electronic circuit, a processor 203 (shared, dedicated, or group) and memory 205 that execute one or more software or firmware programs, a combinational logic circuit, and/or other suitable components that provide the described functionality.

In some embodiments, the modules may include, for example, a receiving module 217, an object identification module 219, a location identification module 221, a retrieving module 223, a virtual marker module 225 and other modules 229. The other modules 229 may be used to perform various miscellaneous functionalities of the AR system 103. It will be appreciated that such aforementioned modules may be represented as a single module or a combination of different modules.

In an embodiment, the other modules 229 may be used to perform various miscellaneous functionalities of the AR system 103. It will be appreciated that such modules may be represented as a single module or a combination of different modules. Furthermore, a person of ordinary skill in the art will appreciate that in an implementation, the one or more modules may be stored in the memory 205, without limiting the scope of the disclosure. The said modules when configured with the functionality defined in the present disclosure will result in a novel hardware.

In an embodiment, the receiving module 217 may be configured to receive an image from an image capturing device 101. As an example, the image capturing device 101 may be a camera. The image capturing device 101 may also capture videos. The videos may be divided into one or more frames or images for further processing by the AR system 103. Upon receiving the image, object classification may be performed to identify presence of objects in the image using a classifier. The classifier may perform this using thresholding technique. For example, a threshold value may be set as 60. When the classifier classifies data of the image, it returns a confidence value for the image being classified. If the confidence value received by the classifier is greater than 60, then the desired object may be identified in the image. However, if the confidence value received by the classifier is less than 60 then the desired object may not be present in the image.

In an embodiment, the object identification module 219 may be configured to identify one or more objects in the received image. As an example, the received image may be of an engine and the one or more objects of interest in the engine may be one or more parts of the engine such as pipe, nut, bolt and the like. In an embodiment, the one or more objects of interest may be identified using a machine learning technique. At first the one or more features in the image may be extracted and the features may be learnt by the machine learning model to identify the one or more objects of interest. The identified one or more objects of interest may be stored as object data 207.

In an embodiment, the location identification module 221 may be configured to identify the location of each of the objects of interest in the image. The identified location may be stored as location data 209. As an example, there may be two objects of interest in the image such as a pipe and a bolt which are identified by the object identification module. In an embodiment, image segmentation may be used for locating the objects and boundaries of the objects in the image. As an example, segmentation technique such as region growing, and thresholding technique may be used for segmentation to identify the location of the objects.

In an embodiment, the retrieving module 223 may be configured to retrieve a virtual marker for each object identified in the image. In an embodiment, the virtual marker may be represented as a 2-dimensional image. Each object may be associated with a virtual marker which may be stored in a virtual marker repository 109 associated with the AR system 103. The virtual marker may be stored as virtual marker data 211. Once the object is identified, the virtual marker corresponding to the virtual marker may be retrieved from the virtual marker repository 109. Thereafter, the virtual marker module 225 may place the virtual marker at the identified location for each object of interest in the image. In an embodiment, the virtual marker may also be masked or overlaid on the image using masking techniques.

Further, the image with the virtual marker may be provided to a client device 105. The client device 105 may include, but not limited to, a mobile phone, a laptop, a tablet and any other computing device hosting an AR application. The AR application may be a native application of the client device 105 or a web-based application. Upon receiving the image at the client device 105, the AR application may identify the virtual marker in the image corresponding to each of the one or more objects of interest. The AR application may implement a machine learning model which is trained with images of virtual markers. Once the image is received at the client device 105, the AR application may compare the one or more virtual markers in the image with plurality of virtual markers stored in the augmented data repository 107 to identify a match. Based on the match, the AR application may identify the one or more virtual markers in the received image. Thereafter, the AR application may retrieve the augmented information stored as augmented reality data 213 corresponding to each virtual marker from the augmented data repository. The augmented information may be in the form which includes, but not limited to, a text, a video or an audio. The retrieved augmented information may be added to each virtual marker so that when the image is displayed on a display interface of the client device 105, each object of interest in the image is provided with the augmented information. As an example, the augmented information may include, but not limited to, type of the object, name of the object, shape of the object, specification of the object and the like.

### Example Illustration

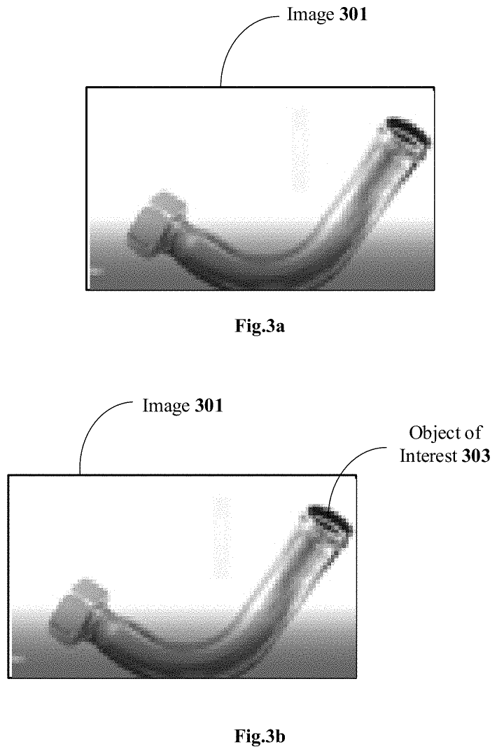

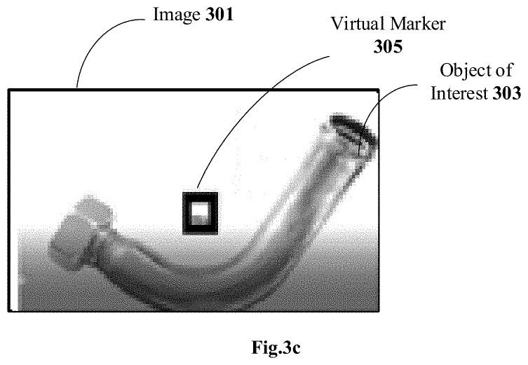

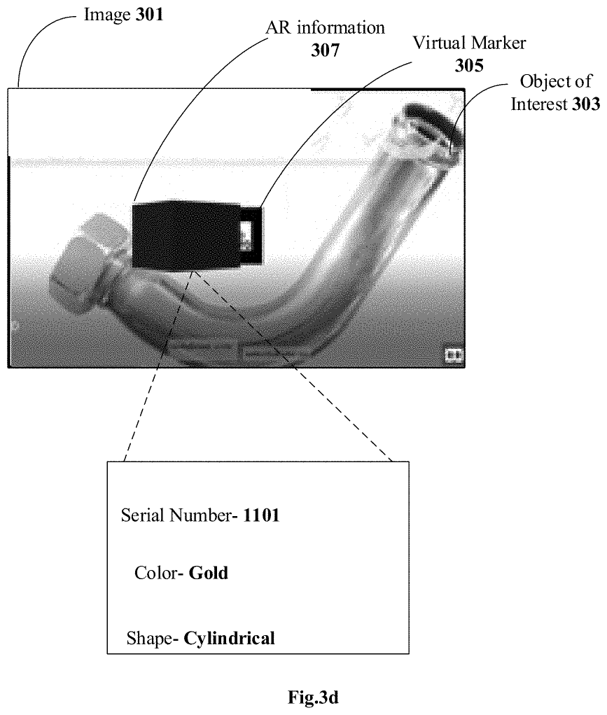

FIG. 3a shows an image captured by an image capturing device 101. The AR system 103 receives the captured image 301. Upon receiving the image 301, the AR system 103 identifies one or more regions of interest in the image using machine learning model. The image is provided to the machine learning model. The machine learning model extracts one or more features in the image and learns the one or more features to identify one or more objects of interest. As an example, the machine learning model identifies the object of interest 303 as “pipe” as shown in FIG. 3b based on the learnt features of the “pipe”. Once the object of interest 303 is identified, the AR system 103 identifies location of the object of interest in the image. The location is identified using segmentation technique. The AR system 103 retrieves the virtual marker 305 corresponding to the identified object of interest from the virtual marker repository 109 associated with the AR system 103. The retrieved virtual marker 305 is placed at the identified location in the image as shown in FIG. 3c. Once the image 301 is added with the virtual marker 305, the image is provided to the client device 105. At the client device 105, the AR application in the client device 105 identifies the virtual marker 305 in the image 301 and retrieves augmented reality information 307 for the virtual marker corresponding to the identified object of interest 303. The augmented reality information 307 comprises serial number of the pipe, shape of the pipe and color of the pipe. The retrieved AR information 307 is added to the virtual marker 305 and the virtual marker 305 along with the AR information 307 is as shown in FIG. 3d. The user of the client device 105 may hover or click the virtual marker 305 to view the augmented reality information 307. This enables the user using the AR application to identify the object being displayed with the help of characteristics of the object augmented visually.

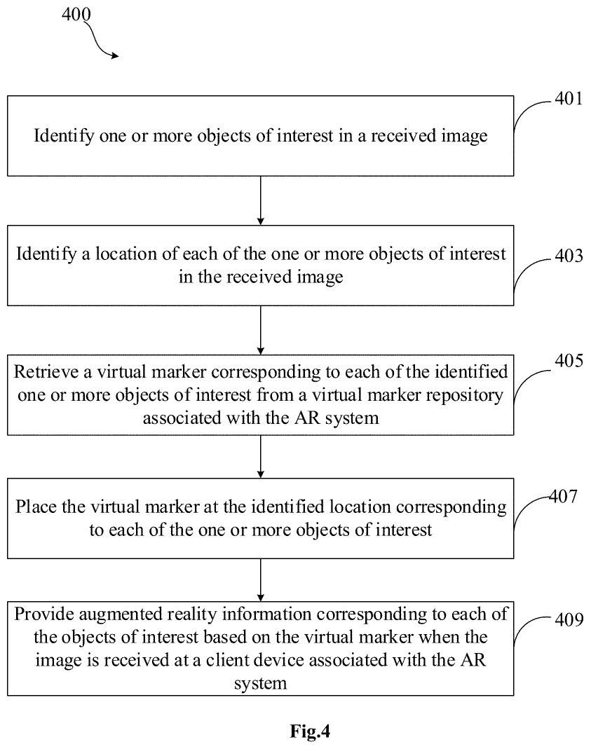

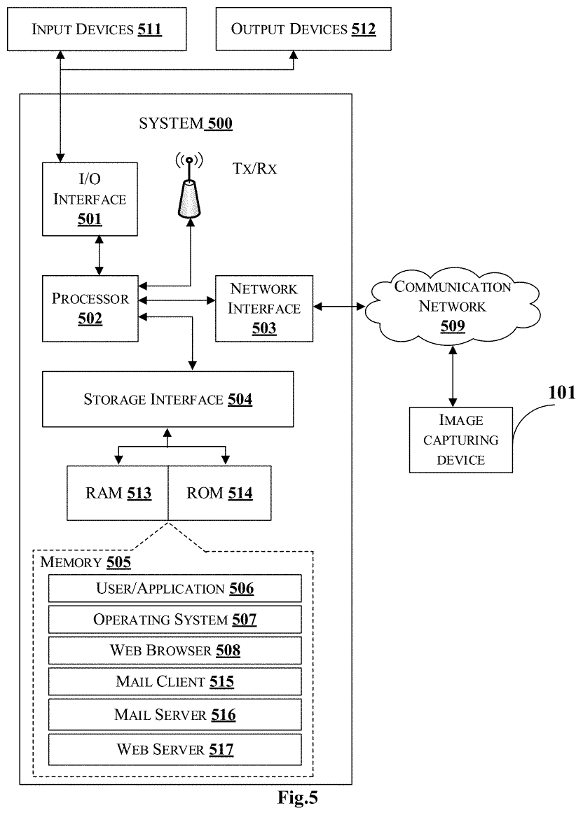

FIG. 4 shows a flowchart illustrating a method of providing augmented reality information for an object in accordance with some embodiments of the present disclosure; and

As illustrated in FIG. 4, the method 400 includes one or more blocks illustrating a method of providing augmented reality information for an object. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the method may include identifying, by an Augmented Reality (AR) system 103, one or more objects of interest in a received image. The AR system 103 may receive the image from an image capturing device 101. To identify the one or more objects of interest, the AR system 103 may first extract one or more features in the image. The extracted features may be trained using machine learning techniques to identify the one or more objects of interest.

At block 403, the method may include identifying, by the AR system 103, location of each of the one or more objects of interest in the received image. As an example, but not limited to, the location may be identified using image segmentation techniques.

At block 405, the method may include retrieving, by the AR system 103, a virtual marker corresponding to each of the identified one or more objects of interest from a virtual marker repository 109 associated with the AR system 103. Each object may be associated with the virtual marker. The virtual marker may be represented as a 2-dimensional image.

At block 407, the method may include placing, by the AR system 103, the virtual marker at the identified location corresponding to each of the one or more objects of interest.

In an embodiment, once the virtual marker is placed, the image may be provided to a client device 105. The client device 105 may be configured with AR application. The AR application may identify the virtual marker in the received image. Once the virtual marker is identified, the AR application may retrieve augmented reality information for each of the identified virtual marker from an augmented data repository. The AR application may add the AR information for each virtual marker and at block 409, the AR application may provide the AR information to each of the object of interest when the image is displayed on a display interface of the client device 105.

### Computer System

FIG. 5 illustrates a block diagram of an exemplary computer system 500 for implementing embodiments consistent with the present disclosure. In an embodiment, the computer system 500 may be an Augmented Reality (AR) system 103, which is used for providing augmented reality information for an object. The computer system 500 may include a central processing unit (“CPU” or “processor”) 502. The processor 502 may comprise at least one data processor for executing program components for executing user or system-generated business processes. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512. The computer system 500 may receive an image for processing from an image capturing device 101.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 509 can be implemented as one of the several types of networks, such as intranet or Local Area Network (LAN) and such within the organization. The communication network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application 506, an operating system 507, a web browser 508, mail client 515, mail server 516, web server 517 and the like. In some embodiments, computer system 500 may store user/application data 506, such as the data, variables, records, etc. as described in this invention. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIXR, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, APPLE MACINTOSH® operating systems, IBM™ OS/2, MICROSOFT™ WINDOWS™ (XP™, VISTA™/7/8, 10 etc.), Unix® X-Windows, web interface libraries (e.g., AJAX™, DHTML™, ADOBE® FLASH™, JAVASCRIPT™, JAVA™, etc.), or the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method and system for providing augmented reality information for an object.

In an embodiment, the present disclosure provides a method for placing a virtual marker for objects rather than physical markers and hence cost efficient. Also, user can choose type of image to be used as a virtual marker.

In an embodiment, the present disclosure implements a machine learning model for automatically identifying one or more objects of interest in the image and for placing virtual markers for the objects of interest.

In an embodiment, in the present disclosure only the image along with virtual markers are provided to a client device. At the client device augmented information is provided and hence no need to transmit augmented information to the client device, hence optimal and also quickly renders the augmented information.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Architecture |
| 101 | Image capturing device |
| 103 | Augmented Reality system |
| 105 | Client device |
| 107 | Augmented data repository |
| 109 | Virtual marker repository |
| 201 | I/O interface |
| 203 | Processor |
| 205 | Memory |
| 207 | Object data |
| 209 | Location data |
| 211 | Virtual marker data |
| 213 | Augmented reality data |
| 215 | Other data |
| 217 | Receiving module |
| 219 | Object identification module |
| 221 | Location identification module |
| 223 | Retrieving module |
| 225 | Virtual marker module |
| 229 | Other modules |
| 301 | Exemplary image |
| 303 | Object of interest |
| 305 | Virtual marker |
| 307 | Augmented information |
| 500 | Exemplary computer system |
| 501 | I/O Interface of the exemplary computer system |
| 502 | Processor of the exemplary computer system |
| 503 | Network interface |
| 504 | Storage interface |
| 505 | Memory of the exemplary computer system |
| 506 | User/Application |
| 507 | Operating system |
| 508 | Web browser |
| 509 | Communication network |
| 511 | Input devices |
| 512 | Output devices |
| 513 | RAM |
| 514 | ROM |
| 515 | Mail Client |
| 516 | Mail Server |
| 517 | Web Server |

What is claimed is:

1. A method of providing augmented reality information for an object, the method comprising:
identifying, by an Augmented Reality (AR) system, one or more objects of interest in a received image;
identifying, by the AR system, a location of each of the one or more objects of interest in the received image;
retrieving, by the AR system, a virtual marker corresponding to each of the identified one or more objects of interest from a virtual marker repository associated with the AR system;
placing, by the AR system, the virtual marker at the identified location corresponding to each of the one or more objects of interest; and
providing, by the AR system, augmented reality information corresponding to each of the objects of interest based on the virtual marker when the image is received at a client device associated with the AR system.

2. The method as claimed in claim 1, wherein the one or more objects of interest is identified in the received image by:
extracting one or more features in the image; and
identifying the one or more objects of interest in the received image by learning the extracted features using a machine learning model.

3. The method as claimed in claim 1, wherein the virtual marker is represented as an image.

4. The method as claimed in claim 1, wherein the image is received from an image capturing device associated with the AR system.

5. The method as claimed in claim 1, wherein providing the augmented reality information comprises:
identifying the virtual marker corresponding to each of the one or more objects of interest in the image received at the client device;
retrieving augmented reality information for each virtual marker corresponding to each of the one or more objects of interest from an augmented data repository;
adding the augmented reality information for each virtual marker; and
providing the augmented reality information corresponding to each of the objects of interest based on the virtual marker.

6. An Augmented Reality (AR) system for providing augmented reality information for an object, the AR system comprising:
a processor; and
a memory communicatively coupled to the processor, wherein the memory stores the processor-executable instructions, which, on execution, causes the processor to:
identify one or more objects of interest in a received image;
identify a location of each of the one or more objects of interest in the image;
retrieve a virtual marker corresponding to each of the identified one or more objects of interest from a virtual marker repository associated with the AR system;
place the virtual marker at the identified location corresponding to each of the one or more objects of interest; and
provide augmented reality information corresponding to each of the objects of interest based on the virtual marker when the image is received at a client device associated with the AR system.

7. The AR system as claimed in claim 6, wherein the processor identifies one or more objects of interest in the received image by:
extracting one or more features in the image; and
identifying the one or more objects of interest in the received image by learning the extracted features using a machine learning model.

8. The AR system as claimed in claim 6, wherein the virtual marker is represented as an image.

9. The AR system as claimed in claim 6, wherein the processor receives the image from an image capturing device associated with the AR system.

10. The AR system as claimed in claim 6, wherein the processor provides the augmented reality information by:
identifying the virtual marker corresponding to each of the one or more objects of interest in the image received at the client device;
retrieving augmented reality information for each virtual marker corresponding to each of the one or more objects of interest from an augmented data repository;
adding the augmented reality information for each virtual marker; and
providing the augmented reality information corresponding to each of the objects of interest based on the virtual marker.

11. A non-transitory computer readable medium including instructions stored thereon that when processed by at least one processor causes the processor to:
identify one or more objects of interest in a received image;
identify a location of each of the one or more objects of interest in the received image;
retrieve a virtual marker corresponding to each of the identified one or more objects of interest from a virtual marker repository 109 associated with the AR system 103;
place the virtual marker at the identified location corresponding to each of the one or more objects of interest; and
provide augmented reality information corresponding to each of the objects of interest based on the virtual marker when the image is received at a client device associated with the AR system.

12. The non-transitory computer readable medium as claimed in claim 11, wherein the instructions causes the processor to identify one or more objects of interest in the received image by:
extracting one or more features in the image; and
identifying the one or more objects of interest in the received image by learning the extracted features using a machine learning model.

13. The non-transitory computer readable medium as claimed in claim 11, wherein the virtual marker is represented as an image.

14. The non-transitory computer readable medium as claimed in claim 11, wherein the instructions causes the processor to receive the image from an image capturing device associated with the AR system.

15. The non-transitory computer readable medium as claimed in claim 11, wherein the instructions causes the processor to provide the augmented reality information by:
identifying the virtual marker corresponding to each of the one or more objects of interest in the image received at the client device;
retrieving augmented reality information for each virtual marker corresponding to each of the one or more objects of interest from an augmented data repository;
adding the augmented reality information for each virtual marker; and
providing the augmented reality information corresponding to each of the objects of interest based on the virtual marker.
